(19) United States
(12) Patent Application Publication
(10) Pub. No.: US 2005/0108906 A1
(43) Pub. Date: May 26, 2005

(54) Address cabinet

(76) Inventor: Clement Phillip, Rowlett, TX (US)

Correspondence Address: Wendell J. Jones, PMB 441, 555 Bryant Avenue, Palo Alto, CA, 94301, US

(21) Appl. No.: 10/998,207

(22) Filed: Nov. 26, 2004

Related U.S. Application Data
(60) Provisional application No. 60/525,320, filed on Nov. 25, 2003.

(51) Int. Cl. G09F 13/04

(52) U.S. Cl. 40/575

(57) ABSTRACT

An article of manufacture is disclosed. The article includes a face portion wherein the face portion includes address information, a housing portion and a plexiglass portion in between the face portion and the housing portion for providing an optimal contrast for displaying the address information.

### FIELD OF THE INVENTION

The present invention relates generally to the field of home improvement and more particularly to an address cabinet.

### BACKGROUND OF THE INVENTION

Conventionally, street address numbers are painted on the curb of an associated building or displayed somewhere on the front of the building. Although these numbers can be seen during daylight hours, it can sometimes be problematic for someone to see the numbers during nighttime hours.

Accordingly, what is needed is a means for displaying address information the addresses the above-described shortcoming. The means should be simple, cost effective and capable of being easily adapted to existing technology.

### SUMMARY OF THE INVENTION

An article of manufacture is disclosed. The article includes a face portion wherein the face portion includes address information, a housing portion and a plexiglass portion in between the face portion and the housing portion for providing an optimal contrast for displaying the address information.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of an address cabinet in accordance with an embodiment of the present invention.

FIG. 2 shows a more detailed illustration of the address cabinet in accordance with an embodiment of the present invention.

FIG. 3 shows a more detailed illustration of the face portion in accordance with an embodiment of the present invention.

FIG. 4 shows a more detailed illustration of the housing portion in accordance with an embodiment of the present invention.

### DETAILED DESCRIPTION

The present invention relates to an address cabinet. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, varying embodiments of an address cabinet are disclosed. Accordingly, an address cabinet that includes address information is fabricated with a plexiglass portion that allows the address information to be illuminated in dark surroundings (e.g. at night) while simultaneously providing an optimum contrast in lighted surroundings (e.g. during daylight). Consequently, the address cabinet displays the address information in an optimum fashion in either daytime or nighttime surroundings.

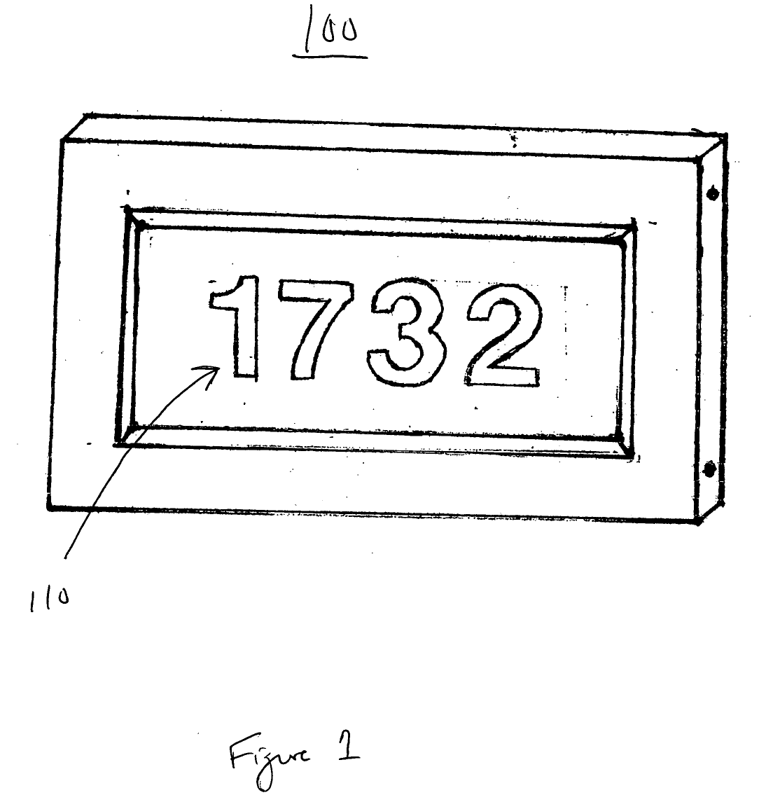

FIG. 1 is an illustration of an address cabinet 100 in accordance with an embodiment of the present invention. As can be seen in FIG. 1, the address cabinet 100 includes address information 110. In an embodiment, the address information 110 includes numbers associated with the address of a building. In this instance, the numbers “1732” could be the numbers associated with the address of a house e.g. 1732 Prospect Avenue.

Although in this particular embodiment the address information 110 includes numbers associated with the address of a building, one of ordinary skill in the art will readily recognize that any type of information could be displayed while remaining within the spirit and scope of the present invention.

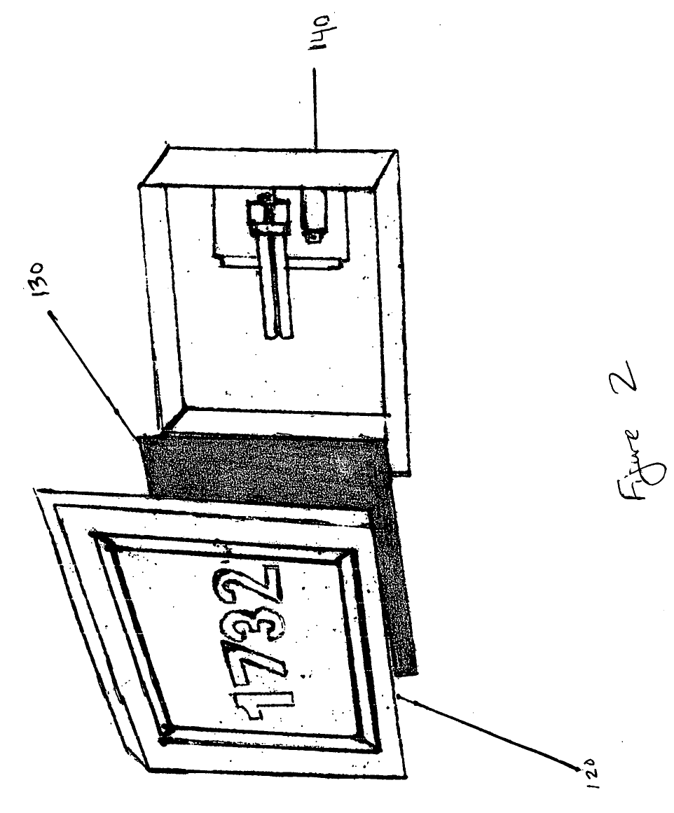

FIG. 2 shows a more detailed illustration of the address cabinet 100 in accordance with an embodiment of the present invention. As can be seen in FIG. 2, the address cabinet 100 includes, a face portion 120, a plexiglass portion 130, and a housing portion 140. Accordingly, the face portion 120 and the plexiglass portion 130 are placed in the housing portion 140 whereby the plexiglass portion 130 is configured to provide an optimum contrast of the information being displayed on the face portion 120.

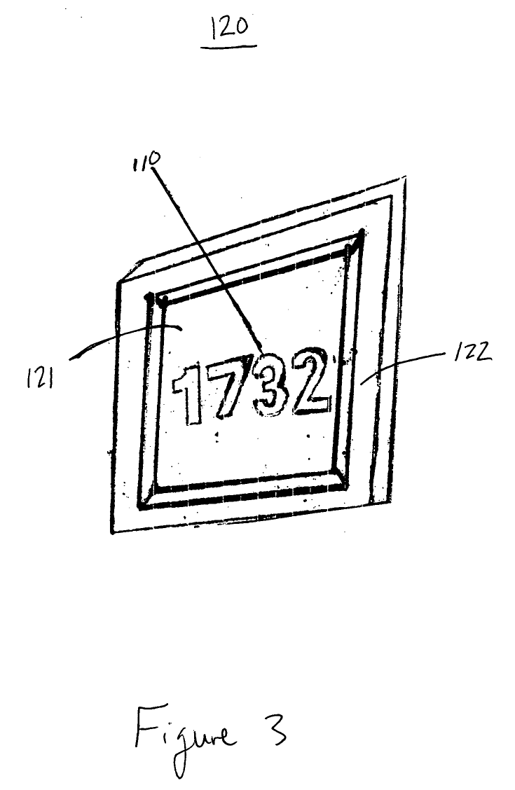

FIG. 3 shows a more detailed illustration of the face portion 120. In an embodiment, the face portion 120 includes a faceplate 121 comprised of an aluminum material whereby the address information 110 is routed out of the aluminum material. The face portion 120 further comprises a retainer portion 122 that retains the faceplate 121 wherein the retainer portion 122 can be comprised of a durable material such as plastic. Additionally, the face portion 120 can be easily removed from the housing portion 140 for easy servicing.

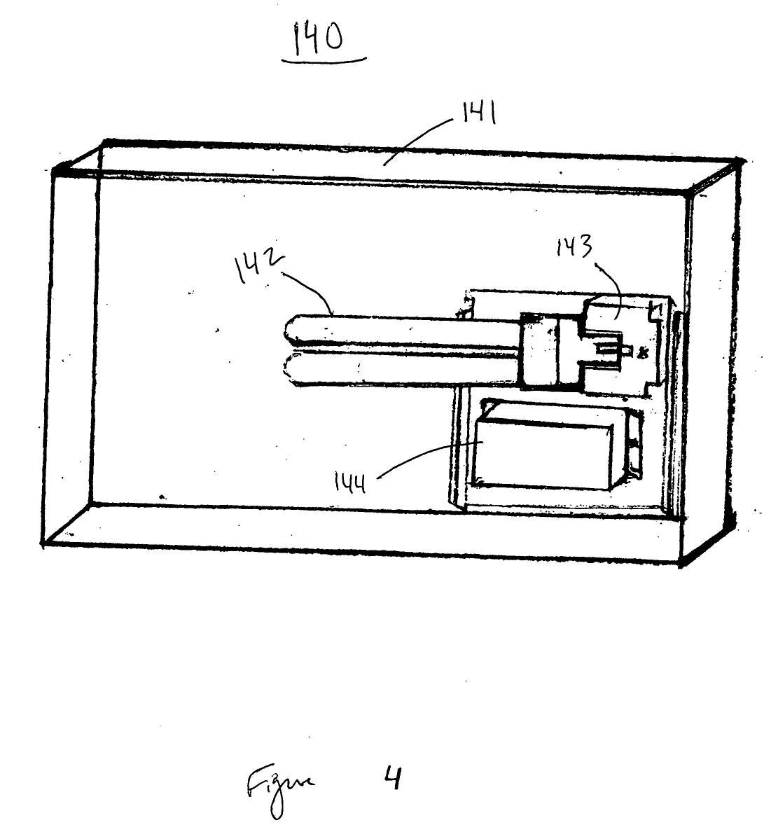

FIG. 4 shows a more detailed illustration of the housing portion 140. In an embodiment, the housing portion 140 includes a housing 141, an illuminating portion 142 and an electrical portion 144 coupled to the illuminating portion 142 for providing power to the illuminating portion 142.

In an embodiment, the housing 141 is comprised of an aluminum material. Furthermore, the illuminating portion 142 comprises a fluorescent lamp and is coupled to the housing 141 via an associated socket 143. Finally, the electrical portion 144 comprises a low voltage transformer capable of powering the fluorescent lamp. This electrical portion 144 can be coupled to a switch (i.e. a porch light switch) in order to readily provide power to the illuminating portion 142 when an illuminated state is desired.

In an embodiment, the plexiglass portion 130 is a black and white plexiglass material. The black and white plexiglass material is beneficial in that when illuminated, the black and white plexiglass material provides a white background for the address information being displayed in the face portion 120. Furthermore, in a non-illuminated state, the black and white plexiglass material provides a black background for the address information being displayed in the face portion 120. Accordingly, this capability allows the plexiglass portion 120 to be utilized in conjunction with the illuminating portion 142 in order to provide an optimum contrast for displaying the address information being displayed in the face portion 120.

For example, during daylight hours, a black background is desirable for optimum contrast. Therefore, the illuminating portion 142 is kept off. However, during nighttime hours, a white background is desirable for optimum contrast. Consequently, the illuminating portion 142 is turned on to provide a white background for displaying the address information being displayed in the face portion 120.

An address cabinet is disclosed. Accordingly, an address cabinet that includes address information is fabricated with a plexiglass portion that allows the address information to be illuminated in dark surroundings (e.g. at night) while simultaneously providing an optimum contrast in lighted surroundings (e.g. during daylight). Consequently, the address cabinet displays the address information in an optimum fashion in either daytime or nighttime surroundings.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. An article of manufacture comprising:
a face portion wherein the face portion comprises address information;
a housing portion; and
a plexiglass portion in between the face portion and the housing portion for providing an optimal contrast for displaying the address information.

2. The article of claim 1 wherein the face portion comprises a plastic retainer and an aluminum portion contained therein.

3. The article of claim 1 wherein the housing portion includes:
an illuminating portion; and
an electrical portion coupled to the illuminating portion for providing power to the illuminating portion.

4. The article of claim 1 wherein the plexiglass portion comprises a black and white plexiglass.

5. The article of claim 1 wherein the article of manufacture comprises an address cabinet.

6. The article of claim 1 wherein the face portion is removable.

7. The article of claim 2 wherein the address information comprises numbers that are routed out in the aluminum portion.

8. The article of claim 3 wherein the illuminating portion comprises a lamp and an associated socket.

9. The article of claim 3 wherein the electrical portion comprises a low voltage transformer.

10. The article of claim 7 wherein the lamp comprises a fluorescent lamp.

11. An address cabinet comprising:
a face portion comprising a plastic retainer and an aluminum face plate contained therein wherein the aluminum face plate includes address information;
a housing portion that includes an illuminating portion and an electrical portion coupled to the illuminating portion for providing power to the illuminating portion; and
a black and white plexiglass placed between the face portion and the housing portion for providing an optimum contrast for displaying the address information.

12. The address cabinet of claim 11 wherein the face portion is removable.

13. The address cabinet of claim 11 wherein the address information comprises numbers that are routed out in the aluminum portion.

14. The address cabinet of claim 13 wherein the illuminating portion comprises a lamp and an associated socket.

15. The address cabinet of claim 13 wherein the electrical portion comprises a low voltage transformer.

16. The address cabinet of claim 14 wherein the lamp comprises a fluorescent lamp.

17. An address cabinet comprising:
a removable face portion comprising a plastic retainer and an aluminum face plate contained therein wherein the aluminum face plate includes numbers that are routed out in the aluminum portion;
a housing portion that includes a fluorescent lamp, an associated socket and an low voltage transformer coupled to the lamp for providing power to the lamp; and
a black and white plexiglass placed between the removable face portion and the housing portion for providing an optimum contrast for displaying the numbers.
